(19) United States
(12) Patent Application Publication
(10) Pub. No.: US 2015/0134424 A1
(43) Pub. Date: May 14, 2015

(54) SYSTEMS AND METHODS FOR ASSESSING HYBRIDIZATION OF CLOUD COMPUTING SERVICES BASED ON DATA MINING OF HISTORICAL DECISIONS

(71) Applicant: VMware, Inc., Palo Alto, CA (US)

(72) Inventors: Dani Matzlavi, Hertzliya (IL); Meidad Etz-Hadar, Hertzliya (IL)

(73) Assignee: VMware, Inc., Palo Alto, CA (US)

(21) Appl. No.: 14/080,661

(22) Filed: Nov. 14, 2013

(51) Int. Cl. G06Q 10/06

(52) U.S. Cl. CPC G06Q 10/0637
USPC 705/7.36

(57) ABSTRACT

Computational methods and systems that aid an enterprise in deciding whether to execute an application entirely within a private cloud or a hybrid combination of the private cloud and public cloud services offered by a public cloud service provider are described. The methods and system receive a set of quantitative parameters associated with running an application using computational services provided by a public cloud service provider and a set of organizational parameters associated with an enterprise. The quantitative and organizational parameters are normalized and input to a decision model that generates a recommendation that indicates exclusive use of a private cloud or a hybrid private cloud and public cloud to execute the application.

### TECHNICAL FIELD

The disclosure is directed to assessing hybridization of private and public cloud computing services using data mining.

### BACKGROUND

Cloud computing has increasingly provided enterprises with opportunities to cut costs and decrease time to market while eliminating a heavy investment in information technology (“IT”) and operating expenses. Cloud computing describes any number of different types of computing using a large number of computers connected through a real-time communication network. For example, cloud computing refers to running a program on many connected computers at the same time and may also refer to network-based services that appear to a user as real server hardware, but, in fact, are virtual machines (“VMs”) simulated by software running on one or more real computers. Because the VMs are not bound to physical resources, the VMs can be moved around and scaled up or down as needed without affecting the user's experience. Cloud computing may also be used to maximize the effectiveness of the shared resources, such as computers, applications, and data storage. Cloud resources are usually not only shared by multiple users but are also dynamically re-allocated based on demand. For example, a cloud computing facility that serves a large number of users during daytime business hours with a first application may reallocate the same resources for a second application used by nighttime customers located elsewhere in the world. This approach maximizes the use of resources.

As a result of cloud computing, enterprises now have the option of deploying applications they use on publically hosted clouds, private internal clouds, or a hybrid of public and private clouds. Private clouds are built for exclusive use by an enterprise, which provides control of data, security, and quality of service. Private clouds may be built and managed within the facilities of the enterprise or may be hosted externally by a private cloud offering. On the other hand, publically hosted clouds are maintained by a public cloud service provider that offers resources like compute power, network, and storage as a service. One benefit of public clouds is that resources maintained by a public cloud service provider are typically much larger than the resources maintained in a private cloud. As a result, public cloud services may be scaled up or down based on demand and the enterprise reduces operational risk and cost of having to maintain a private cloud. Hybrid clouds are a combination of public and private cloud models. Hybrid clouds are designed to extend a private cloud with additional resources offered by a public cloud. For example, an enterprise that typically relies on a private cloud may observe a workload spike that requires additional resources provided by a public cloud.

For the enterprise there is a need to evaluate specific applications by taking into account various parameters, such as security and compliance, and then decide which application fits the private cloud model and which application fits the hybrid cloud model. However, the evaluation process may differ significantly from one enterprise to the next. Currently there is no clear set of criteria enterprises can use to evaluate the decision to exclusively use a private cloud or a hybrid cloud. Enterprises and public cloud service providers seek computational systems and methods to aid in determining whether hybridization will satisfy an enterprise's computational needs and minimize costs.

### SUMMARY

This disclosure presents computational methods and systems that aid an enterprise in deciding whether to execute an application entirely within a private cloud used exclusively by the enterprise or execute the application using a hybrid combination of the private cloud and public cloud services offered by a public cloud service provider. The methods and system receive a set of quantitative parameters associated with running an application using computational services provided by a public cloud service provider and a set of organizational parameters associated with an enterprise. The quantitative and organizational parameters are normalized and input to a decision model that generates a recommendation that indicates exclusive use of a private cloud or a hybrid private cloud and public cloud to execute the application.

### BRIEF DESCRIPTION OF THE DRAWINGS

FIG. 1 shows an example of a private cloud and a hybrid cloud.

FIG. 2 shows an example of a generalized computer system that executes efficient methods for deciding to hybridize services therefore represents a data-processing system.

FIG. 3 shows an automated process for deciding whether or not to execute an application exclusively in a private cloud or in a hybrid private and public cloud.

FIGS. 4A-4B shows example tables of services and associated quantitative and organizational parameters.

FIG. 5 shows a flow-control diagram of a computational method that trains and tests a decision model.

FIG. 6A shows an example of pseudo-code for a learning decision tree.

FIG. 6B shows a simple example of a decision tree.

FIGS. 7A-7B shows an example of neural networks and neural network pseudo-code.

FIG. 8 shows a simple example of a feed-forward neural network.

FIG. 9 shows a flow diagram of a computational method for aiding an enterprise in deciding to hybridize or not to hybridize an application.

FIG. 10 shows an example of normalized hybridization values for five services.

FIG. 11 shows an example of normalized hybridization values for the five services shown in FIG. 10 with noise applied.

FIG. 12 shows an example of a decision tree generated using a J48 method for a test set of hybridization parameters.

FIG. 13 shows a table of results for the decision tree shown in FIG. 12 based on the test set of hybridization parameters.

FIGS. 14A-14C shows examples of confusion matrices that represent the results for a neural network using the test set of hybridization parameters used to generate the decision tree in FIG. 12.

FIG. 15 shows a table of J48 and neural network results where the hybridization parameters and noise were varied.

### DETAILED DESCRIPTION

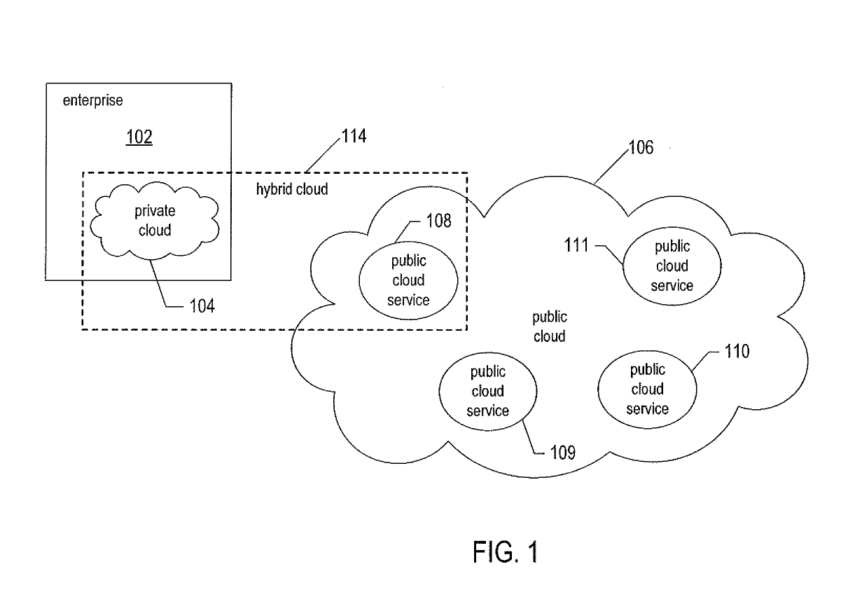

This disclosure presents computational methods and systems that aid an enterprise in deciding whether to execute an application entirely within a private cloud used exclusively by the enterprise or execute the application using a hybrid combination of the private cloud and public cloud services offered by a public cloud service provider. FIG. 1 shows an example of an enterprise 102 that maintains execution of an application using a private cloud 104. The enterprise 102 may be a business, an individual, a government agency, a non-profit, or any other organization. The application may be computer software or a computer program. The private cloud 104 is a cloud infrastructure composed of computers, servers, data-storage devices, an internal network and may also include virtual machines (“VMs”) and virtual servers (“VSs”) operated solely by the enterprise 102 to execute the application and may be managed and hosted internally by the enterprise 102 or may be managed and hosted by a third-party exclusively for the enterprise 102. FIG. 1 also shows a representation of a public cloud 106 with various public cloud services 108-111 managed by public cloud service providers. Each public cloud service provider maintains a cloud infrastructure of computers, servers, data-storage devices, an internal network, VMs, and VSs over a network that is open for public use. Typically, public cloud service providers own and maintain the cloud infrastructure and offer access to computing services over the Internet. It may be the case that the enterprise 102 lacks sufficient computational resources to execute the application entirely within the private cloud 104. In such cases the enterprise 102 may consider using a hybrid cloud model in which the application runs in the private cloud 104 and is also run in one or more of the public cloud services 108-111. For example, as shown in FIG. 1, a hybrid cloud 114 is formed from the private cloud 104 and the public clouds services 108 provided by a public cloud service provider to execute the same application. A primary advantage of forming a hybrid cloud is that the enterprise 102 only pays for extra compute services when needed. The enterprise 102 may use the private cloud 104 to support typical computational workloads but forms a hybrid cloud 114 using cloud resources offered by a public cloud service provider during temporary spikes in processing demands. The computational methods and systems described herein use quantitative parameters that relate to executing the application using the public cloud services 108 and organizational parameters that relate to the organization of the enterprise 102 in order to computationally provide a recommendation the enterprise 102 may use in deciding to execute the application using either the private cloud 104 or the hybrid cloud 114.

It should be noted at the onset that data related to determining whether or not to run a service in a private cloud or in a hybridized private and public cloud is not, in any sense, abstract or intangible. Instead, the data is necessarily digitally encoded and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems on electronically or magnetically stored data, with the results of the data processing and data analysis digitally encoded and stored in one or more tangible, physical, data-storage devices and media.

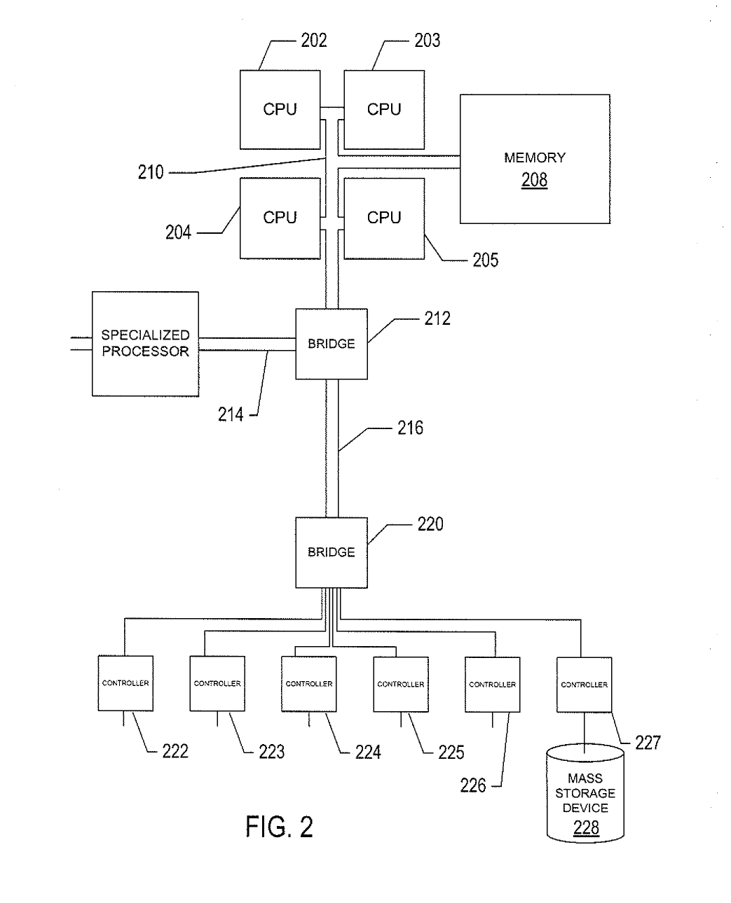

FIG. 2 shows an example of a generalized computer system that executes efficient methods for deciding to hybridize services therefore represents a data-processing system. The internal components of many small, mid-sized, and large computer systems as well as specialized processor-based storage systems can be described with respect to this generalized architecture, although each particular system may feature many additional components, subsystems, and similar, parallel systems with architectures similar to this generalized architecture. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216, or other types of high-speed interconnection media, including multiple, high-speed serial interconnects. The busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to various different types of computer-readable media, such as computer-readable medium 228, electronic displays, input devices, and other such components, subcomponents, and computational resources. The electronic displays, including visual display screen, audio speakers, and other output interfaces, and the input devices, including mice, keyboards, touch screens, and other such input interfaces, together constitute input and output interfaces that allow the computer system to interact with human users. Computer-readable medium 228 is a data-storage device, including electronic memory, optical or magnetic disk drive, USB drive, flash memory and other such data-storage device. The computer-readable medium 228 can be used to store machine-readable instructions that encode the computational methods described below and can be used to store encoded data, during store operations, and from which encoded data can be retrieved, during read operations, by computer systems, data-storage systems, and peripheral devices.

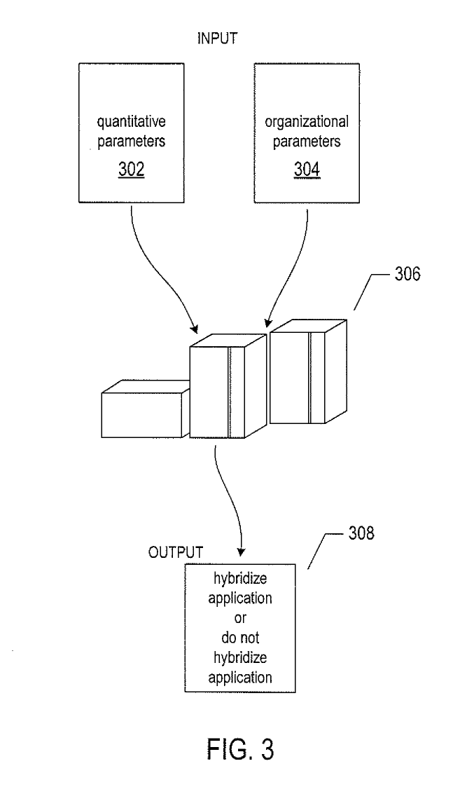

FIG. 3 shows an automated process for deciding whether or not to execute an application exclusively in a private cloud or in a hybrid private and public cloud. As shown in FIG. 3, quantitative parameters 302 regarding running the application in a public cloud and organizational parameters 304 regarding the enterprise's managerial practices are input to an automated computer system 306. The computer system 306 executes a decision model that receives the quantitative parameters 302 and the organizational parameters 304 as input and outputs a recommendation 308 the enterprise may use in deciding whether to hybridize the application or not to hybridize the application. The decision model implemented by the computer system 306 may be a computational machine learning technique that is trained using training sets of historical quantitative and organization parameters and performance measures associated with hybrid models of other enterprises. The decision model may also be updated using the quantitative and organization parameters 302 and 304 of the enterprise.

The quantitative parameters may be, for example, cost, computing resources, number of dependencies, and performance service level agreement (“SLA”), which are described as follows:

Cost. The cost is the cost per service, such as the cost of using a VM for a period of time. The cost is a metric that defines the IT cost of any service. The overall cost consists of the hardware, storage, network, maintenance, and VMs. The cost can vary between different public cloud service providers and can be measured in any currency. The cost of a service includes the cost of using all the infrastructure selected to run service for a period of time plus any other computing or infrastructure services. For example, the cost of a service may be given as $2,500 a year. While the cost of maintaining a service in the public cloud is known and may be constant per service, the delta cost, denoted by Δcost, can be calculated for each service. The Δcost is the difference between the cost of running the service in the public cloud minus the cost running it entirely in the private cloud. The Δcost may be positive most of the time, but it may also be the cases that the Δcost will be negative.

Computing resources. Each service offered by a public cloud service provider requires certain computing resources. Some services use only a few resources while others use much more. These computing resources can, be classified as reported computing resources or actual computing resources. Examples of reported computing resources include the number of virtual CPUs, CPU reservation, virtual memory, memory reservation, number of disks and disk size. In particular, the CPU and memory may be provided as gigabytes. Examples of actual computing resources include current memory used by a guest operating system, current CPU used by the guest operating and current disk usage. A public cloud service provider that maintains these computing resources may be both time-consuming and complex. As a result, services may use additional computing resources, which may result in scaled-up and scale-out computational operations. Public clouds are theoretically unlimited, from a computing resources point of view, and most public cloud service providers offer dynamic resources allocations. The decision model assumes that enterprises tend to hybridize on the basis of the volume of resources that a service needs.

Number of Dependencies. The number of dependencies may be determined by the number of connections in and out of a VM and the number of applications that a VM is part of. The number of dependencies may range from as few at 0 to many thousands of dependencies. Hybridization often occurs in a transitional phase, where an enterprise incrementally increases the number of services provided by public cloud service providers, while most of the enterprises services remain in the private cloud. Services with a high number of dependencies are typically not good candidates for hybridizing, because the impact on other services is high. This quantitative parameter often stands in correlation to the level of application criticality described below under organizational parameters. The decision model is based on the assumption that the smaller the number of dependencies a service has the more likely it is that the enterprise will choose to hybridize.

Performance SLA. Services comply with performance SLAs that may be represented as a percentage, such as 99.8% availability and 99.9% uptime. Services that are constantly at high load levels might be closer to missing SLA requirements. As a result, performance metrics such as hit rate latency and application performance index are monitored.

Examples of organizational parameters include criticality, regulations, and organizational approach, which are described as follows:

Criticality. A service is critical to an enterprise when there is a negative impact on the core business of the enterprise as a result of the service being down or exhibiting a low performance. The level of criticality may be a significant parameter in a hybridization decision. Criticality is measured by the level of importance assigned to a service and is correlated directly to the SLA level and others parameters to indicate how important a services is to the running the application to the enterprise. The criticality values range from 0 (i.e., non-critical) to 1 (i.e., super critical).

Regulations. Internal and external regulations, such as privacy, may prevent or limit the decision to hybridize. For example, the enterprise may be an insurance company or a bank, in which case, the enterprise is precluded from allowing any information relating to customers from being transferred to a cloud that is not exclusively under the control, management, and security of the enterprise. This parameter is a differential parameter because its value alone may completely determine the decision to hybridize. Regulations are static, such as when an enterprise cannot have their data located outside a particular country and values assigned to this regulation are binaries with, for example, “0” indicated that hybridization is prohibited or “1” indicated that there are currently no regulations that prohibit hybridization.

Organizational approach. Because enterprises are composed of people with different opinions and beliefs, there may be traditional enterprises that resist moving forward with the latest technology and prefer to make the transition only after the technology has reached a certain level of maturity and has been thoroughly evaluated by others. On the other hand, there are enterprises that are on the cutting edge of technology and are less apprehensive to use the latest technological resources. The decision model is constructed under the assumption that enterprises that are equipped with the latest technology are more likely to use public cloud services. Organizational approach is a measured of the level of maturity assigned to the enterprise and may be measured by the amount of current services already in the public cloud. For example, a value assigned to represent the organizational approach may be the number of services an enterprise already uses in the public cloud.

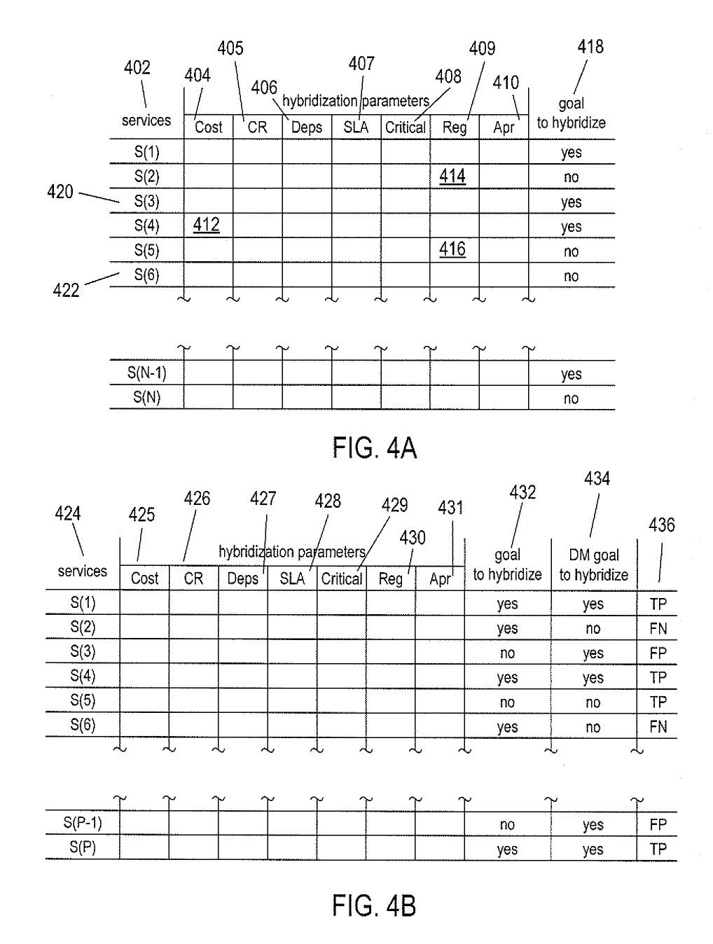

FIG. 4 shows an example table of historical services and associated quantitative and organizational parameters and goals. The table of historical services, quantitative and organizational parameters, and goals may be used to train a decision model. A first column 402 represents N services offered by a public cloud service provider. In this example, columns 404-407 represent the quantitative parameters of cost, computing resources (“CR”), number of dependencies (“Deps”), and performance SLA, respectively. Columns 408-410 represent the organizational parameters of criticality (“Critical”), regulations (“Reg”), and organizational approach (“Apr”), respectively. The quantitative and organization parameters associated with the N services are referred to as hybridization parameters used to train the decision model. Each box in the columns 404-410 may represents a numerical value. For example, box 412 represents the cost of providing a service S(4) in monetary units per unit of time, and boxes 414 and 416 represent regulations that either prohibit or allow hybrid cloud services associated with services S(2) and S(5). Regulations may be represented by binary values “0” and “1,” where “0” represents a regulation that expressly prohibits hybridization and “1” represents regulations that do not prohibit hybridization. Column 418 represents a goal to hybridize or not based on the service and the associated set of hybridization parameter values in a row. For example, when the service S(3) is offered with hybridization parameters listed in row 420 the result is to hybridize, and when the service offered is S(6) with hybridization parameters listed in row 422 the result is not to hybridize.

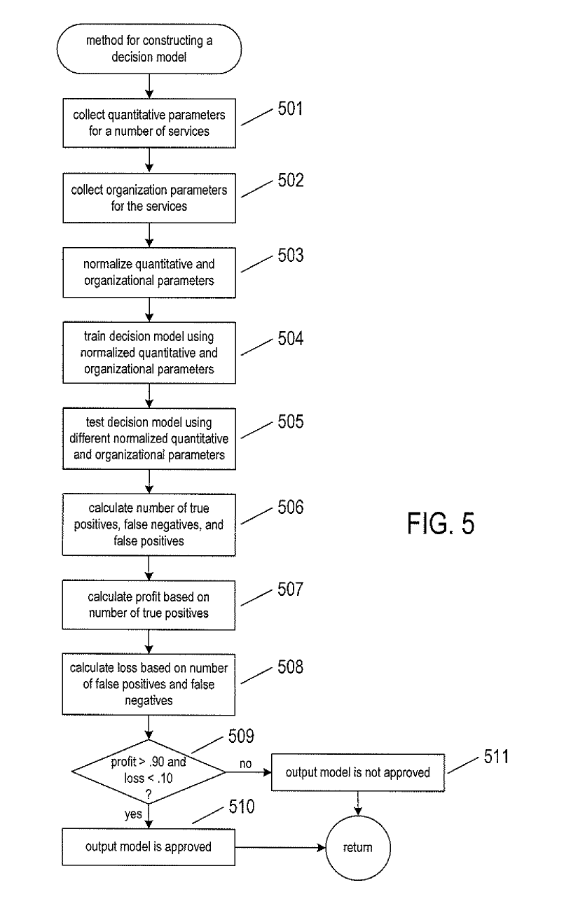

FIG. 5 shows a flow-control diagram of a computational machine learning method that trains a decision model used to generate a recommendation to hybridize an application or not to hybridize the application for an enterprise. In block 501, historical quantitative parameters for a number of services offered by a public cloud service provider are collected. In block 502, historical organizational parameters regarding the managerial practices of enterprises that use private clouds and/or hybrid clouds are collected. The historical quantitative and organizational parameters are the hybridization parameters used to train the decision model as described above with reference to FIG. 4. In block 403, the hybridization parameters are normalized to the interval [0,1]. The hybridization parameters may vary in scope but each parameter's contribution to the decision model is considered regardless of its absolute value. For example, where the number of dependencies varies from 0 to 100 and the cost varies from 1,000 to 10,000, the absolute differences between the value levels should not impact the model. Therefore, all hybridization parameter values are normalized to the interval [0,1]. Any one of many different mathematical techniques may be used to normalize the hybridization parameter values associated with a hybridization parameter. For example, the hybridization parameters may be normalized to the interval [0,1] using:

$$\hat{h} ( j ) = \frac{h ( j )}{\sqrt{{\sum }_{i = 1}^{N} {[ h ( i ) ]}^{2}}}$$

where h(j) represents the jth hybridization parameter value of a hybridization parameter.

In block 504, the normalized hybridization parameters are used to train a decision model that can be used to recommend hybridization.

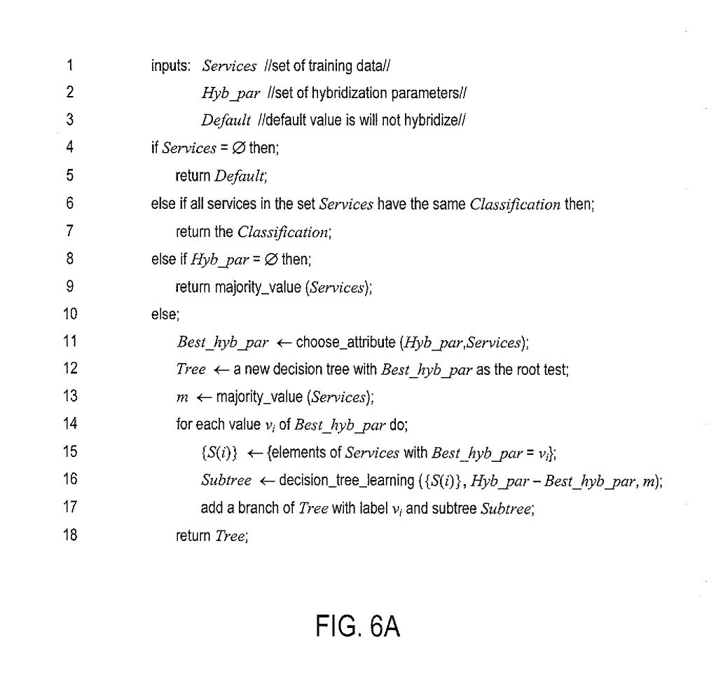

FIG. 6A shows an example of pseudo-code for a learning decision tree that may be used to construct a decision tree-based decision model. A decision tree first performs a test in order to identify the most important hybridization parameter first. The most important hybridization parameter is the parameter that makes the most significant difference in recommending whether or not to hybridize. The inputs used to construct a decision tree-based decision model are listed in lines 1-3. The term “Services” represents a list of N service, the term “Hyb_par” represents the set of hybridization parameter values, and the term “Default” represents a default value which is a recommendation to not hybridize. Lines 4 and 5 address the case where the set of “Services” is empty resulting in the “Default” recommendation of not to hybridize. Lines 6 and 7 address the case where all services in the set of “Services” have the same hybridization “Classification” of either “yes” or “no,” in which case, the “Classification” is recommended. Lines 8 and 9 address the case where the set of hybridization parameters “Hyb_par” is empty, in which case, the majority hybridization value of either yes or no is recommended. In line 11, a best hybridization parameter denoted by “Best_hyb_par” is selected. The “Best_hyp_par” is the hybridization parameter that provides the largest information gain given by:

Gain(Best_hyb_par)=I(Best_hyb_par)−R(Best_hyb_par)

where

$$I ( Best\_hyb \_par ) = - \frac{p}{p + n} {log}_{2} \frac{p}{p + n} - \frac{n}{P + n} {log}_{2} \frac{n}{p + n}$$

is an estimate of the information content of “Hyb_par;” and

$$R ( Best\_hyb \_par ) = {\sum }_{i = 1}^{v} \frac{{p}_{i} + {n}_{i}}{p + n} I ( Best\_hyb \_par )$$

is the remainder, with p the number of yes hybridizations associated with “Hyb_par,” n the number of no hybridizations associated with the “Hyb_par,” and v is the number of distinct values for “Hyb_par.”

Lines 12-18 describe a process of constructing the remainder of the decision tree. Consider, in particular, the hybridization parameter Regulations, which has two distinct values (i.e., “0” for no and “1” for yes). The number n is the number of no hybridizations associated with Regulations and the number p is the number of yes hybridizations associated with Regulations. The Regulations typically has the largest Gain of the hybridization parameters, because the Regulations are tied directly to the decision to hybridize. If there are regulations prohibiting hybridization, then the decision is not to hybridize. On the other hand, if there are no regulations prohibiting hybridization, then the other hybridization parameters can be used to construct branches of the decision tree. Therefore, initially, the “Best_hyp_par” to use as the root of the decision tree in line 12 is Regulations.

FIG. 6B shows a simple example of decision tree. Each node of the decision tree corresponds to a hybridization parameter and the two directional arrows extending from each node represents a vᵢ determined during training. The root of the decision tree is the regulation 602. The leaves of the decision tree are denoted by A, B, and P, where A represents a high probability of hybridization, B represents do not hybridize, and P represents do not hybridize due to Regulations that prohibit hybridization. The decision tree is traversed for an input set of normalized hybridization parameter values by comparing each of the normalized hybridization parameter values with the decision values extending from each node. For example, if the normalized hybridization parameter of Hyb_par(1) is less than the vᵢ as represented by directional arrow 604, the output is a recommendation not to hybridize as represented by decision tree stopping at the leaf B. On the other hand, if the normalized hybridization parameter of Hyb_par(1) is greater than or equal to vᵢ as represented by directional arrow 606, the output is a recommendation to hybridize with a probability represented by the decision tree stopping at the leaf A. When the decision model is a decision tree the output is one of the leafs A, B, or P.

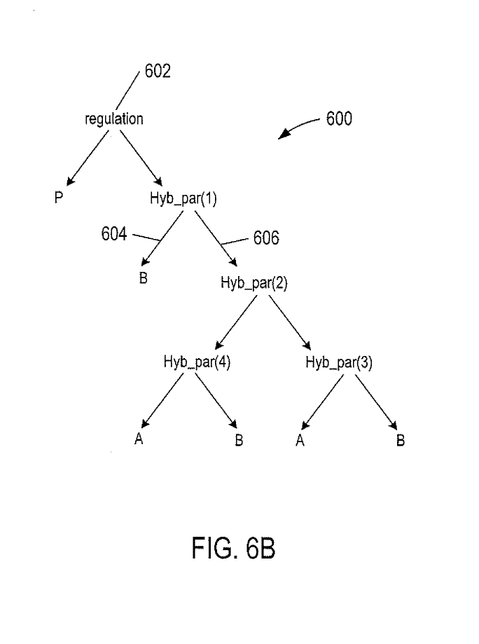

FIGS. 7A-7B shows an example of neural networks and neural network pseudo-code that may be used to construct a neural network-based decision model. Neural networks are a computational modeling technique that changes structure during a training and can be used to model complex relationships between an input layer denoted by \vec{Q} and an output layer denoted by \vec{R}. The input layer \vec{Q} is composed of the hybridization parameter values represented by a column vector:

$$\overline{Q} = [ \begin{matrix}{q}_{1} \\ {q}_{2} \\ {q}_{3} \\ ⋮ \\ {q}_{M}\end{matrix} ]$$

where qⱼ represents the jth hybridization parameter value; and
M is the number of hybridization parameters.
   For example, q₁, q₂, . . . , and qₘ represent the M hybridization parameters values in a row of the table shown in FIG. 4. The output layer \vec{R} is represented in column vector notation as follows:

$$\overline{R} = [ \begin{matrix}{r}_{1} \\ {r}_{2} \\ {r}_{3} \\ ⋮ \\ {r}_{K}\end{matrix} ]$$

where rᵢ represents the ith output value, and
K represents the number of outputs.
   Although the following description presents a general description of neural networks, the output layer for the current method is composed of the single value r₁, where r₁ is a probability of recommending hybridization A, no hybridization B, or prohibits hybridization according to Regulations P. Training is achieved by adjusting numerical weights in a network until the network-action computing performance is acceptable. FIG. 7A shows a graph of an example neural network 700 for determining a relationship between the output layer \vec{R} and the input layer \vec{Q}. The neural network 700 includes an input layer 702, two hidden layers 704 and 706, and an output layer 708. The input layer 702 is composed of nodes that correspond to the elements of \vec{Q}, and the output layer 708 is composed of nodes that correspond to the elements of \vec{R}. Hidden layers 704 and 706 are composed of nodes that represent hidden units denoted by aᵢ. Hidden layer 704 is composed of F nodes that correspond to F hidden units, and hidden layer 706 is composed of G nodes correspond to G hidden units. Certain pairs of nodes are connected by links or edges, such as link 710, that represent weights denoted by W′ⱼᵢ. Each weight determines the strength and sign of a connection between two nodes. It should be noted that neural networks are not limited to two hidden layers and a fixed number of nodes in each layer. The number of hidden layers and number of nodes in each hidden layer can be selected based on computation efficiency. In other words, the number of hidden layers can range from a few as one to some number greater than two, and the number of nodes in each hidden layer is not limited.

FIG. 7B presents an example of a pseudo-code for multilayer feed-forward neural networks that execute learning through back propagation. The number of layers in the neural network is denoted by a positive integer L. It should be noted that this pseudo-code is not intended to limit the number of steps or to be exhaustive of the numerous ways in which a multilayer feed-forward neural networks can be implemented, but is instead provided as one example of a computation approach to computing the relationship between an input layer and an output layer. In line 1, the weights W′ⱼᵢ are initialized to values between 0 and 1. The weights can be initialized using a random number generator that assigns a randomly computed value between 0 and 1 to each of the weights. In lines 4-6, the training input and output data are received. Each operational data element is a node in the input layer, and each registration data element is a node in the output layer. In the for-loop beginning in line 7, each node qⱼ in the input layer is assigned to a hidden unit aⱼ. In the for-loop beginning in line 9, for each layer l between 2 and L, h(sumᵢ) is calculated and assigned to a hidden unit aᵢ for each node, where h is an activation function. The activation function, h, can a threshold activation function that outputs 1 when the input is positive and 0 otherwise. Alternatively, the activation function can be a sigmoid function. Examples of sigmoid activation functions include h(sumᵢ)=tan h(sumᵢ) and h(sumᵢ)=1/(1+e^{-sum}^{ᵢ}). In the for-loop beginning in line 12, for each node in the output layer an error Errorᵢ and a modified error Δᵢ are calculated, where h′ represents the first derivative of the activation function h. The modified error corresponds to a fraction of the error in the nodes of the output layer. In line 15 a for-loop that executes back propagation and weight updates begins with L−1 and ends with the input layer (i.e., l=1). In the for-loop beginning in line 16, the modified error is calculated for each hidden layer l, and in the for-loop beginning in line 18, the weights are updated for each node in the hidden layer l+1. In the for-loop beginning in line 20, when the Errorᵢ for each node in the output layer is less than a defined error threshold, lines 4 through 21 are repeated for another set of hybridization parameters. Otherwise, if one of the errors Errorᵢ exceeds or equals the predefined threshold, lines 9 through 21 are repeated. Note that in other embodiments rather than using a threshold, lines 9 through 19 can be repeated for a preset number of iterations.

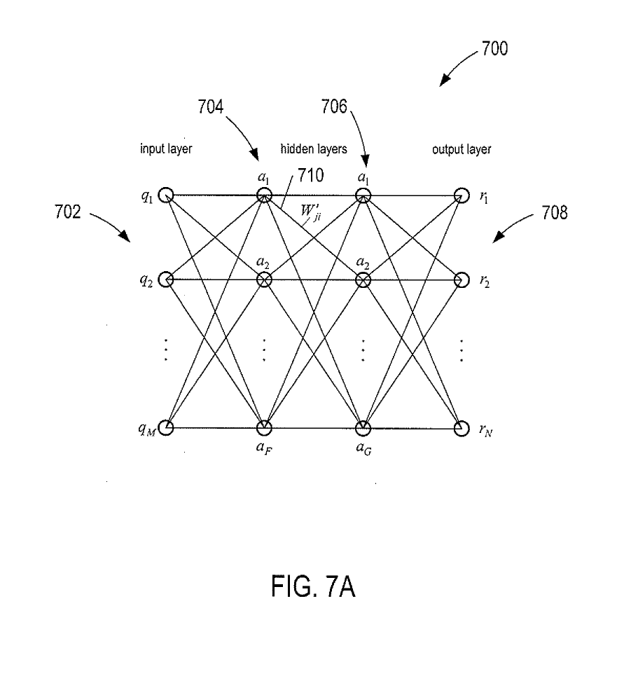

Lines 4 through 21 can be repeated for a large set of training data in order to computationally generate a set of weights that define a relationship between the input layer and the output layer. FIG. 8 shows a simple example of a feed-forward neural network 800 with an input layer composed of two data elements q₁ and q₂ and an output layer composed of a single data element r₁. In this example only one hidden layer composed of three hidden units a₁, a₂, and a₃ is selected to determine a set of weights. In FIG. 8, a first set of weights that link the operational data elements q₁ and q₂ to the hidden units a₁, a₂, and a₃ are denoted by W′₁₁⁽¹⁾, W′₂₁⁽¹⁾, W′₁₂⁽¹⁾, W′₁₃⁽¹⁾, W′₂₂⁽¹⁾, and, W′₂₃⁽¹⁾, and a second set of weights that link the hidden units a₁, a₂, and a₃ to the registration data elements r₁ and r₂ are denoted by W′₁₁⁽¹⁾, W′₂₁⁽¹⁾, W′₃₁⁽¹⁾, W′₁₂⁽¹⁾, W′₂₂⁽¹⁾, and, W′₃₂⁽¹⁾. The weights can be calculated using a feed-forward neural network, such as the pseudo-code described above with reference to FIG. 7B. In the example of FIG. 8, an expression 802 is derived from the neural network for the output r₁.

Returning to FIG. 5, in block 505, the decision model generated using the training set of historical services, hybridization parameters, and goals is tested using a different test set of historical services, hybridization parameters, and goals represented by a table in FIG. 4B. Columns 424-432 represent services, hybridization parameters, and goals as described with reference to FIG. 4A. For each row of normalized hybridization parameter values of the test set input to the decision model a decision model goal to hybridize or not to hybridize is generated using the decision model trained using the training set. Column 434 represent goals generated by the decision model for each row of normalized hybridization parameter values. The goals generated by the decision model in column 434 are compared with the goals in column 432. Column 436 list the results of comparing the decision model goals in column 434 with the test goals listed in column 432. When a goal generated by the decision model in column 434 is compared with the goal in column 432, the comparison results are listed as true positive, denoted by TP, false positive, denoted by FP, or false negative, denoted by FN. A true positive TP is the decision model output recommendation to hybridize and is correct based on the corresponding goal in column 432. A false positive FP is the decision model recommendation to hybridize but this is a wrong decision based on the corresponding goal in column 432. And false negative FN is the decision model recommendation not to hybridize but this is a wrong decision based on the corresponding goal in column 432.

Returning to FIG. 5, in block 507, a profit is calculated according to a profit function as follows:

profit=#TP*ΔCost

where #TP is the number of true positives generated by testing the decision model.

For example, #TP is the number of true positives in column 436 of the table in FIG. 4B. In block 508, a loss is calculated according to a loss function given by:

loss=#FP*(SLA violation cost*#violation+ΔCost on other services*#dependencies)+#FN*ΔCost

where
#FP is number of false positives generated by testing the decision model;
“SLA violation cost” is cost of violated the SLA;
“#violation” is the number of SLA violations;
“ΔCost on other services” is the total cost of other services;
“#dependencies” is the number of dependencies; and
#FN is the number of false negatives generated by testing the decision model.
   For example, #FP is the number of false positives in column 436 of the table in FIG. 4B, and #FN is the number of false negatives in column 436 of the table of FIG. 4B. In block 508, when the profit is greater 0.90 and the loss is less the 0.10, the decision model is acceptable and the method proceeds to block 510, otherwise the method proceeds to block 511.

It should be noted that the method described above with reference to FIG. 5 may also include strategies that adjust the test data to include noise. This may be accomplished by adding noise to the hybridization parameter test data. The objective is to have a stable decision model in the range of [0.10%] noise.

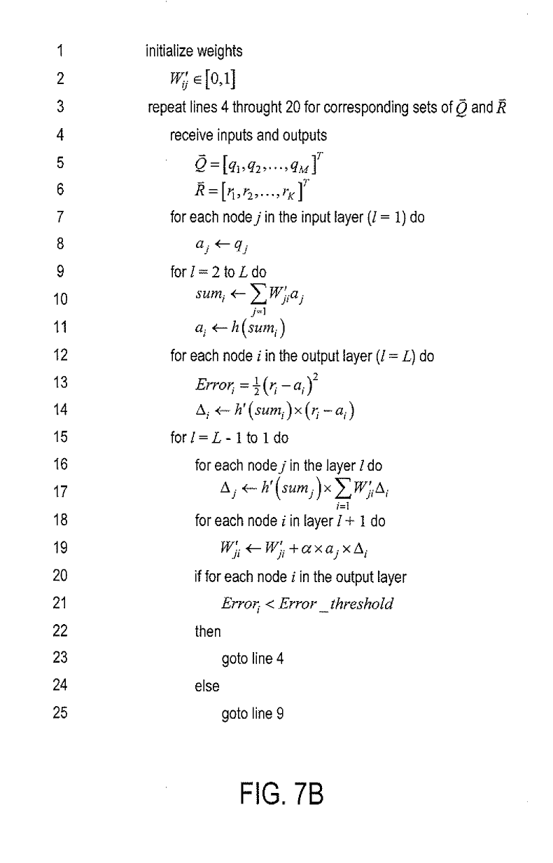

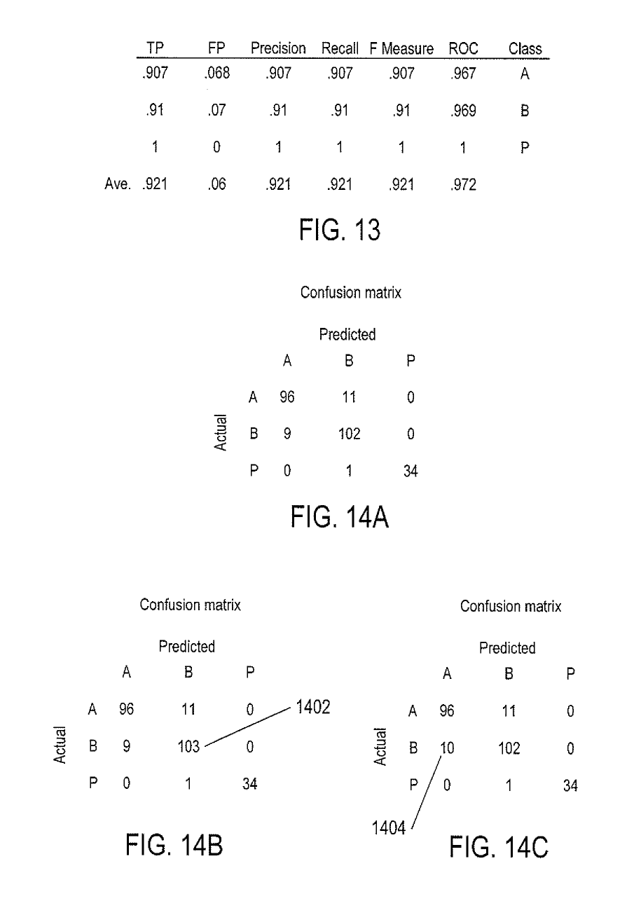

After the decision model has been generated using training data and tested and approved using a set of test data as described in above, the decision model can be used to aid an enterprise in deciding whether to execute an application using a private cloud or a hybrid private and public cloud. FIG. 9 shows a flow diagram of a computational method for aiding in the decision to hybridize or not to hybridize an application. In block 901, a set of quantitative parameters associated with running the application using computational services provided by a public cloud service provider are received. The quantitative parameters may include cost, computing resources, number of dependencies, and a performance SLA. In block 902, a set of organizational parameters associated with the enterprise are received. The organization parameters may include criticality, regulations, and the enterprises organizational approach to cloud computing. In block 903, the quantitative and organizational parameters are normalized with respect to the hybridization parameters in the set of training data or the test set. For example, the parameters can be normalized with respect to the set of training data as follows:

$${\hat{h}}^{′} = \frac{{h}^{′}}{\sqrt{{\sum }_{i = 1}^{N} {[ h ( i ) ]}^{2} + {h}^{′}}}$$

where
{h(i)}ᵢ₌₁^{N} represents the N hybridization parameter values of a hybridization parameter in the training set; and
h′ represents an unnormalized hybridization parameter value of the hybridization parameter input to the decision model.
   In block 904, the normalized quantitative parameters and normalized organizational parameters are input to the decision model. The decision model may be a decision tree, as described above with reference to FIG. 6B, or the decision model may a neural network as described above with reference to FIGS. 7A and 8. In block 905, the decision model outputs are used to recommend to the enterprise to use a private cloud or use a hybridized cloud. For example, when the decision model is a decision the decision tree leads to the values A, B, or P. When the decision model is a neural network, the output is a confusion matrix that is compared with an ultimate confusion matrix. The confusion matrix provides an indication of how many inputs were classified correctly. In particular, assume a set of correct training values is input to the neural network decision model with correct input values. The output of the neural network using a training set with correct input values is an ultimate confusion matrix that is used to give a baseline for the inputs in blocks 901 and 902. The inputs in blocks 901 and 902 are included in the correct training set that is then input to the neural network, which gives a confusion matrix that is compared with the ultimate confusion matrix. If the confusion matrix is an improvement then the assumption regarding the inputs is assumed correct. If, on the other hand, the confusion matrix is worse than the ultimate confusion matrix, the assumption regarding the inputs is assumed incorrect. Examples of confusion matrices and a decision based on the confusion matrices is described below with reference to FIGS. 14A-14C. The enterprise may use the output from the decision model to aid in deciding whether or not to hybridize the application.

### Examples

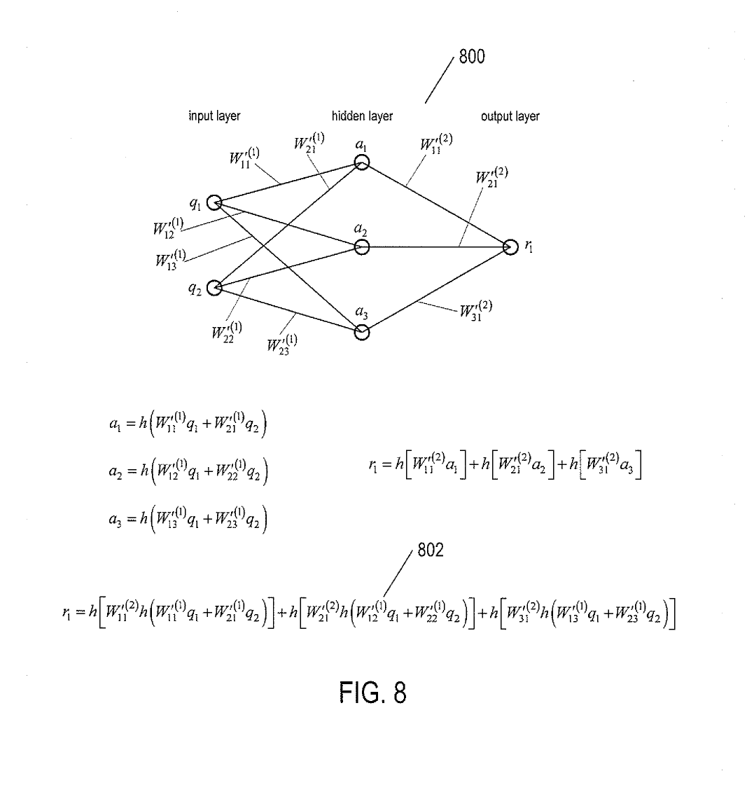

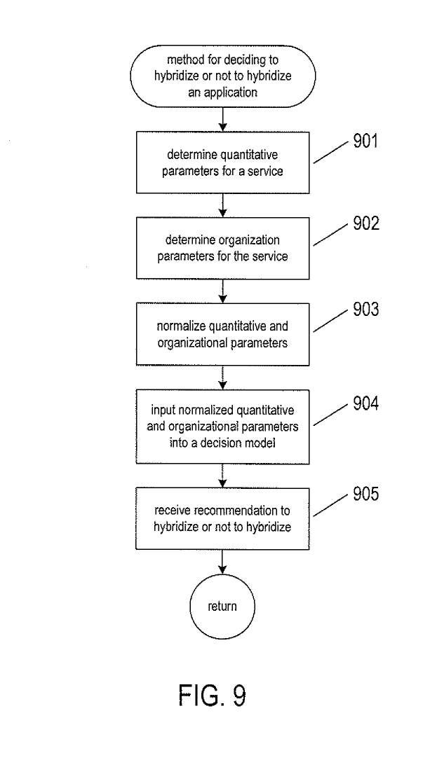

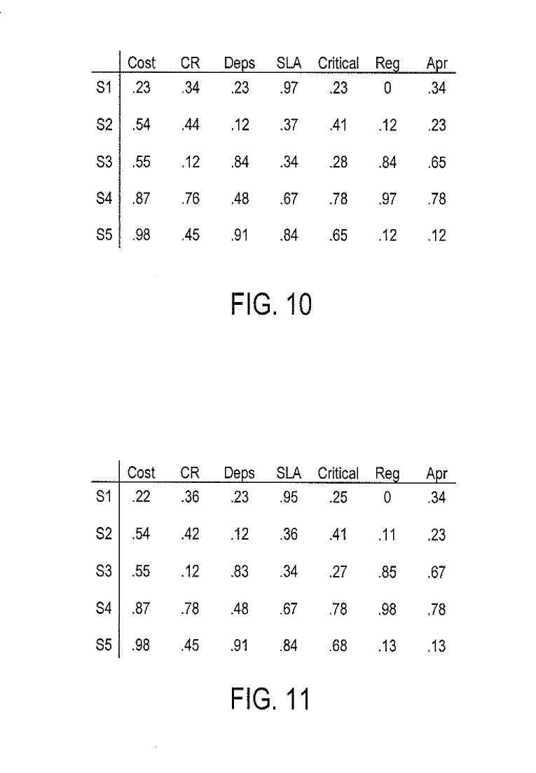

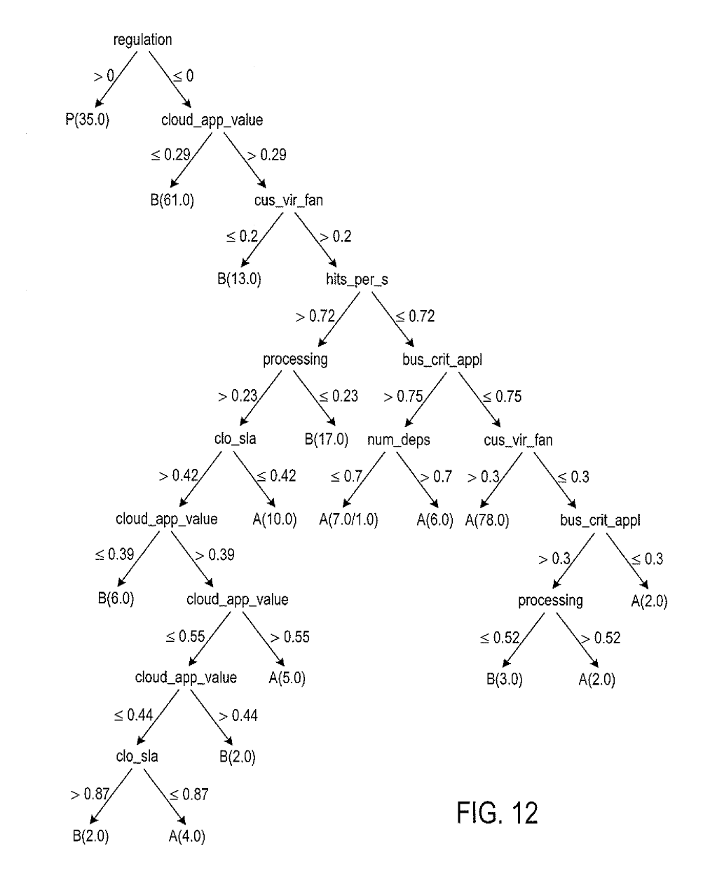

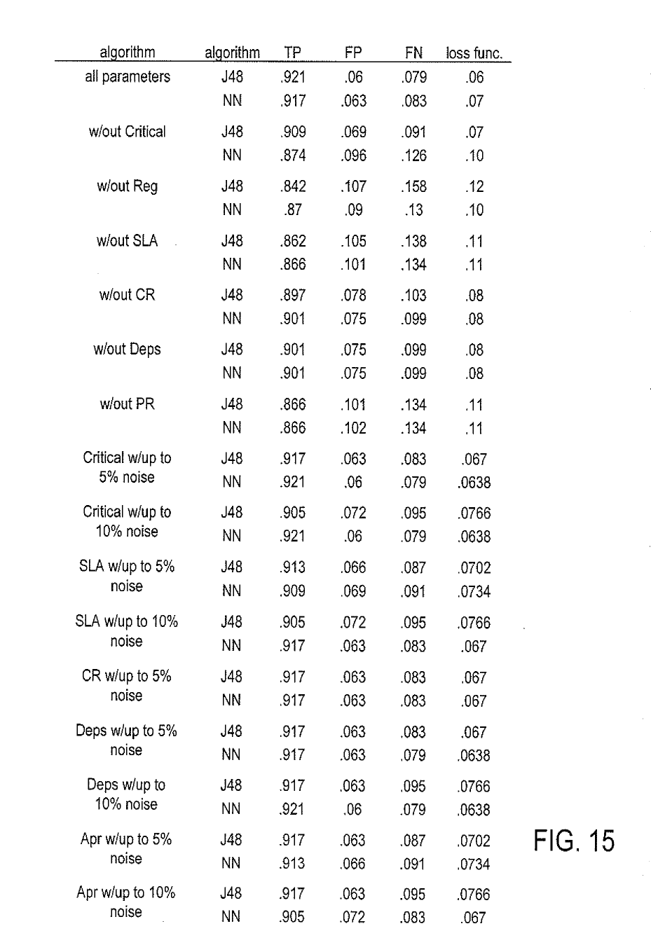

FIG. 10 shows an example of normalized hybridization values for five services. FIG. 11 shows an example of normalized hybridization values for the same five services with noise applied. FIG. 12 shows an example of a decision tree generated using the J48 method using a training set of hybridization parameters. The J47 method is an implementation of the C4.5 method for generating a decision tree. The C4.5 method is based on a data set of trail execution. In each execution, the method determines the hybridization parameter that divides the various samples into the best subsets, as described above with reference to the pseudo-code shown in FIG. 6. The result is a decision tree that guides the user to a set of decisions leading to the right answer. FIG. 13 shows a table of results for the decision tree shown in FIG. 12 based on the training set. The results show the fraction of TP is greater than 90% and the fraction of FP is less than 10% when predicting A, B, and P. FIG. 14A shows a confusion matrix that represents the results for a neural network using the same training set used to generate the decision tree and results in FIGS. 12 and 13. The diagonal elements represent number of times the neural network made a correct prediction, and the off-diagonal elements represent the number of times the neural network made an incorrect prediction. For example, the results show that the neural network correctly predicted A 96 times out of 107 A's in the training set, but incorrectly predicted 11 B's in the training set that should have been A's. The neural network correctly predicted B 102 times out of 111 B's in the training set, but incorrectly predicted 9 A's in the training set that should have been B's. FIGS. 14B-14C shows confusion matrices that result from the training set including additional input parameters. In these examples, the confusion matrix in FIG. 14A is used as the ultimate confusion matrix when comparing the confusion matrices in FIGS. 14B-14C, as described above with reference to block 905 in FIG. 9. In FIG. 14B, the diagonal value 1402 under B increased from 102 to 103, indicating that the prediction of no hybridization was correctly predicted. In other words, the true positives, TP, increase. In FIG. 14C, the off-diagonal value 1402 increased from 9 to 10, indicating that the prediction of hybridization was incorrectly predicted. In other words, the false positives, FP, increase. FIG. 15 shows a table J48 and neural network results where inclusion of the hybridization parameters and noise were varied.

Although the above disclosure has been described in terms of particular embodiments, it is not intended that the disclosure be limited to these embodiments. Modifications within the spirit of the disclosure will be apparent to those skilled in the art. For example, any of a variety of different implementations of machine learning techniques can be obtained by varying any of many different design and development parameters, including programming language, underlying operating system, modular organization, control structures, data structures, and other such design and development parameters.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system for aiding an enterprise in deciding to execute an application in a private cloud or in a hybrid private cloud and public cloud, the system comprising:
one or more processors;
one or more data-storage devices; and
a routine stored in the data-storage devices that when executed using the one or more processors
receives a set of quantitative parameters associated with running the application using computational services provided by a public cloud service provider;
receives a set of organizational parameters associated with the enterprise;
normalizes the quantitative and organizational parameters;
inputs the normalized quantitative and organization parameters to a decision model that generates a recommendation that indicates exclusive use of a private cloud or a hybrid private cloud and public cloud to execute the application; and
stores the recommendation on the one or more data-storage devices.

2. The system of claim 1, wherein the set of quantitative parameters comprises one or more of cost of service, computing resources, number of dependencies, and performance service level agreement.

3. The system of claim 1, wherein the set of organization parameters comprises one or more of criticality, regulations, and the enterprises organization approach.

4. The system of claim 1, wherein the decision model comprises a decision tree generated from a training set of services, quantitative and organization parameters, and hybridization goals, each goal indicating a decision to hybridize or not to hybridize based on a service and corresponding quantitative and organization parameters.

5. The system of claim 1, wherein the decision model comprises a neural network generated from a training set of services, quantitative and organization parameters, and hybridization goals, each goal indicating a decision to hybridize or not to hybridize based on a service and corresponding quantitative and organization parameters.

6. The system of claim 1, wherein the recommendation output from the decision model comprises one of a recommendation to hybridize with an associated probability, a recommendation not hybridize, and instructions not to hybridize based regulations that prohibit the enterprise from hybridizing the application.

7. A method stored in one or more data-storage devices and executed using one or more processors that aids an enterprise in deciding to execute an application in a private cloud or in a hybrid private cloud and public cloud, the method comprising:
receiving a set of quantitative parameters associated with running an application using computational services provided by a public cloud service provider;
receiving a set of organizational parameters associated with an enterprise;
normalizing the quantitative and organizational parameters;
inputting the normalized quantitative and organization parameters to a decision model that generates a recommendation that indicates exclusive use of a private cloud or a hybrid private cloud and public cloud to execute the application; and
storing the recommendation on the one or more data-storage devices.

8. The method of claim 7, wherein the set of quantitative parameters comprises one or more of cost of service, computing resources, number of dependencies, and performance service level agreement.

9. The method of claim 7, wherein the set of organization parameters comprises one or more of criticality, regulations, and the enterprises organization approach.

10. The method of claim 7, wherein the decision model comprises a decision tree generated from a training set of services, quantitative and organization parameters, and hybridization goals, each goal indicating a decision to hybridize or not to hybridize based on a service and corresponding quantitative and organization parameters.

11. The method of claim 7, wherein the decision model comprises a neural network generated from a training set of services, quantitative and organization parameters, and hybridization goals, each goal indicating a decision to hybridize or not to hybridize based on a service and corresponding quantitative and organization parameters.

12. The method of claim 7, wherein the recommendation output from the decision model comprises one of a recommendation to hybridize with an associated probability, a recommendation not hybridize, and instructions not to hybridize based regulations that prohibit the enterprise from hybridizing the application.

13. A computer-readable medium encoded with machine-readable instructions that implement a method carried out by one or more processors of a computer system to perform the operations of
receiving a set of quantitative parameters associated with running an application using computational services provided by a public cloud service provider;
receiving a set of organizational parameters associated with an enterprise;
normalizing the quantitative and organizational parameters;
inputting the normalized quantitative and organization parameters to a decision model that generates a recommendation that indicates exclusive use of a private cloud or a hybrid private cloud and public cloud to execute the application; and
storing the recommendation on the one or more data-storage devices.

14. The medium of claim 13, wherein the set of quantitative parameters comprises one or more of cost of service, computing resources, number of dependencies, and performance service level agreement.

15. The medium of claim 13, wherein the set of organization parameters comprises one or more of criticality, regulations, and the enterprises organization approach.

16. The method of claim 7, wherein the decision model comprises a decision tree generated from a training set of services, quantitative and organization parameters, and hybridization goals, each goal indicating a decision to hybridize or not to hybridize based on a service and corresponding quantitative and organization parameters.

17. The medium of claim 13, wherein the decision model comprises a neural network generated from a training set of services, quantitative and organization parameters, and hybridization goals, each goal indicating a decision to hybridize or not to hybridize based on a service and corresponding quantitative and organization parameters.

18. The medium of claim 13, wherein the recommendation output from the decision model comprises one of a recommendation to hybridize with an associated probability, a recommendation not hybridize, and instructions not to hybridize based regulations that prohibit the enterprise from hybridizing the application.
